(19) United States
(12) Patent Application Publication
(10) Pub. No.: US 2011/0273089 A1
(43) Pub. Date: Nov. 10, 2011

(54) CERAMIC GAS DISCHARGE METAL HALIDE LAMP WITH HIGH COLOR TEMPERATURE

(75) Inventors: Alexander Dunaevsky, Pittsford, NY (US); Jay Palmer, Hammondsport, NY (US)

(73) Assignee: KONINKLIJKE PHILIPS ELECTRONICS N.V., EINDHOVEN (NL)

(21) Appl. No.: 13/144,501

(22) PCT Filed: Jan. 5, 2010
(86) PCT No.: PCT/IB10/50024

§ 371 Date: Jul. 14, 2011

Related U.S. Application Data
(60) Provisional application No. 61/144,522, filed on Jan. 14, 2009.

(51) Int. Cl. H01J 61/20

(52) U.S. Cl. 313/639

(57) ABSTRACT

A ceramic gas discharge metal halide (CDM) lamp (23) exhibiting a high color temperature (above 4500K) has a prolate spheroid-shaped PCA discharge vessel (12) containing a fill of an inert gas, mercury and a metal halide salt mixture of at least about 62 mole percent of calcium iodide (CaI₂); up to about 8 mole percent of cerium iodide (CeI₃); up to about 15 mole percent of cesium iodide (CsI); and up to about 15 mole percent of other halides selected from the halides of lithium (Li), sodium (Na), indium (In), manganese (Mn), lead (Pb), praseodymium (Pr), europium (Eu), gallium (Ga) and thallium (Tl), with the amount of sodium (Na) halides being less than about 5 mole percent, and the amount of thallium (Tl) halides being less than about 5 mole percent. Such lamps are particularly useful in horticultural applications, as well as in sports lighting, aquarium lighting and other specialty lighting applications.

This invention relates to ceramic gas discharge metal halide (CDM) lamps, and more particularly relates to such lamps which utilize a polycrystalline alumina (PCA) ceramic gas discharge vessel containing an arc discharge-sustaining fill which includes a mixture of metal halide salts.

CDM lamps typically employ a PCA ceramic discharge vessel surrounded by an outer glass envelope and a base sealed to the envelope to provide a gas-tight enclosure. The discharge vessel has a certain shape to accommodate high internal pressure and provide minimal thermal gradients. The discharge vessel contains a fill of an inert gas, a salt mixture and mercury, capable of sustaining an arc discharge between a pair of discharge electrodes situated at opposing ends of the discharge vessel. The discharge electrodes are connected to the base via frame wires, which also support the discharge vessel.

The particular combination of metal halides and their proportions in the salt mix largely determines lamp characteristics such as lumen output, the correlated color temperature (CCT), and the color rendering index (CRI) of the lamp.

WO 2005/088675 discloses a metal halide lamp with high efficiency and long lifetime, with a CCT in the range of 2500-4500K. The lamp has a chemical fill of sodium iodide (NaI), thallium iodide (TlI), calcium iodide (CaI₂) and iodides selected from Sc, Y, La, Ce, Pr, Gd, Tb, Dy, Ho, Er, Tm, Yb, Lu, and Nd iodide. The disclosed combination of metal iodides in the salt mix is said to result in low corrosion of the discharge vessel, which is required to reach a long lifetime.

A disadvantage of the lamp described in WO 2005/088675 is that the CCT is limited, usually to a value below 4500K. Higher CCTs are not possible because of significant amounts of sodium halide (e.g., 70 mole percent) in the salt mix.

U.S. Pat. No. 7,268,495 also discloses a ceramic metal halide lamp with a CCT in the range of 2500-4500K. The lamp has a chemical filling of NaI (at least 5 mol %), TlI, alkaline metal halide which may be CaI₂, and a rare earth halide. The lamp has to have at least one halide of Ba or Sr but may also include CsI.

The lamp of U.S. Pat. No. 7,268,495 is said to have a high efficiency and good color rendering, but as in the case of WO 2005/088675, the CCT is limited to a value of up to 4500K.

In accordance with one form of the invention, a CDM lamp comprises a PCA discharge vessel containing a fill of an inert gas, mercury and a metal halide salt mixture, characterized in that the salt mixture comprises:

at least about 62 mole percent, preferably from about 62 to about 95 mole percent, of calcium iodide (CaI₂);

up to about 8 mole percent, preferably from about 2 to about 6 mole percent, of cerium iodide (CeI₃);

up to about 15 mole percent, preferably from about 3 to about 15 mole percent, of cesium iodide (CsI); and

up to about 15 mole percent of one or more members selected from the group consisting of the halides of lithium (Li), sodium (Na), indium (In), manganese (Mn), lead (Pb), praseodymium (Pr), europium (Eu), gallium (Ga) and thallium (Tl), with the amount of the halides of sodium (Na) being less than about 5 mole percent, and the amount of the halides of thallium (Tl) being less than about 5 mole percent.

The described combination of metal halide salts in combination with the use of a shaped PCA discharge vessel enables the achievement of high correlated color temperatures (CCT) (above 4500K), high luminous efficacy (above 100 Lm/W), high color rendering index (CRI) (85 or higher), and good color stability with low minimum perceptible color differences (MPCD); in addition, the metal halide salt mixture is characterized by low corrosivity, which helps to assure good lumen maintenance and long lifetime for the CDM lamp of the invention.

Such lamps are particularly useful in horticultural applications, as well as in sports lighting, aquarium lighting and other specialty lighting applications.

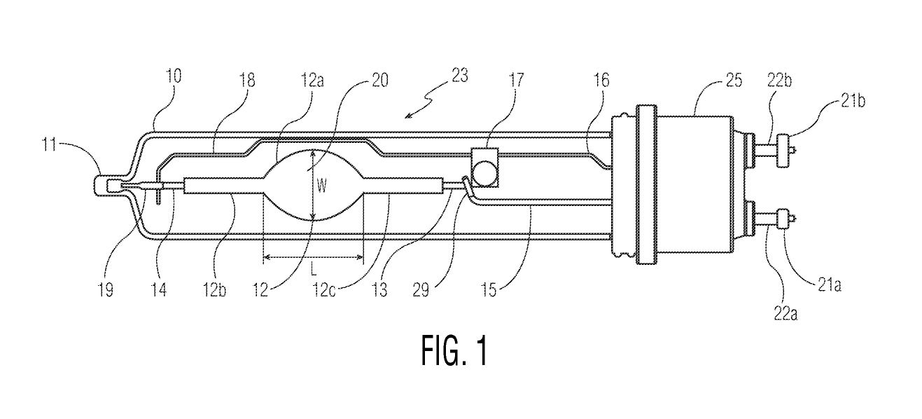

An embodiment of the invention will be described with reference to FIG. 1, which shows a medium wattage ceramic gas discharge metal halide (CDM) lamp with a chemical fill of metal halide salts and a high color temperature according to one embodiment of the invention.

The FIGURE is diagrammatic and not drawn to scale.

More specifically, FIG. 1 shows a medium wattage (315 W) CDM lamp 23 having a PCA discharge vessel 12 including a central prolate spheroid-shaped portion 12a enclosing a discharge space 20, and a pair of tube-shaped end portions 12b and 12c. The central portion 12a of the PCA discharge vessel 12 has a shape and size, defined by a length L along the long axis and a width W along the short axis, designed to accommodate high internal pressure and provide minimal thermal gradients, which leads to high lumen output and long lifetime.

A pair of discharge electrodes 13 and 14 extend through and are supported by the end portions 12b and 12c of the discharge vessel 12 into the discharge space 20. An outer bulb-shaped envelope 10 surrounds the discharge vessel 12 and discharge electrodes 13 and 14 and is sealed to a base 25 to provide an air-tight enclosure.

Electrical leads 22a and 22b, having terminal portions 21a and 21b, respectively, extend through base 25 and are electrically connected to discharge electrodes 13 and 14 via supporting element 15 and supporting frame member 16, respectively. An extension 19 of frame member 16 extends inwardly into a protrusion 11 from the upper end of envelope 10 to provide additional support. A getter 17 is attached to the frame member 16. The discharge space 20 is filled with an inert starting gas, mercury and a chemical filling of a mixture of metal halide salts chosen from CaI₂; CeI₃; CsI and the halides of Li, Na, In, Mn, Pb, Pr, Eu, Ga and Tl.

CeI₃ has a very large number of lines in its emission spectrum, particularly in the blue region, which contributes both to good CRI and high CCT. The total molar quantity of CeI₃ should not exceed 8%, above which corrosion of the PCA wall is likely, resulting in a spongy structure which tends to absorb salts from the discharge space, thus shortening lamp life. Preferably CeI₃ is kept within the range of from about 2 to about 6 mole percent, below which its contribution to the light emission is insufficient for achieving high color temperature and high luminous efficacy, and above which PCA corrosion begins to limit the achievement of a long lamp life.

Within the range of about 4 to 6 mole percent, increasing CeI3 has the effect of increasing luminous efficacy as well as lamp voltage, but with an attendant shift of the color point along the y axis away from the black body radiation curve.

CsI has the effect of stabilizing the arc, preventing arc bending and the attendant PCA wall erosion, to enhance lifetime without adversely affecting the emission spectrum. The molar quantity of CsI should not exceed 15%, above which the luminous efficacy decreases below practical levels. Preferably, the amount of CsI is kept within the range of about 3 to about 15 mole percent, below which the arc stability suffers.

As explained in U.S. Pat. No. 6,031,332, CaI₂ provides good emission properties and a high power factor. CaI₂ also has a low PCA corrosion rate and thus may serve as a solvent to complete the molar percentage of the salt composition to 100 mole percent. Therefore, taking into account maximal molar quantities of other elements, the molar quantity of CaI₂ should be above 62%, particularly from about 62 to 95%, below which the molar quantities of other components exceed their maximal values, and above which the molar quantities of other components would be below their minimal values.

The salt composition may further contain small molar quantities of halides of metals like Li, Na, In, Mn, Pb, Pr, Eu, Ga, or Tl, for fine tuning of the CCT and adjustment of the color point of the lamp with respect to the black body radiation curve. The molar quantity of the fine tuning additions depends on the vapour pressure of the selected halides, but should not exceed 15 mole percent of the total salt mix, above which the PCA corrosion rate makes it impossible to achieve a long lamp life.

In regard to the above group of halides, while the presence of NaI is not essential to achieving a lamp with a high CCT, NaI in particular may be useful for fine tuning of the CCT and adjustment of the color point of the lamp, but in any event should be kept below about 5 mole percent of the total salt mix, above which its influence prevents the achievement of the desired high color temperatures.

In particular, the addition of NaI shifts the color point along the x axis, decreasing the color temperature. Thus, NaI may be used to counteract the effects of CeI3 on the color point, as described above.

Further in regard to the above group of halides, the presence of TlI is likewise not required to achieve a lamp with a high CCT. However, due to an emission spectrum characterized by strong lines in the eye-sensitive region around 535 nm, TlI is also useful for fine tuning of the CCT and adjustment of the color point of the lamp, but in any event should be kept below about 5 mole percent of the total salt mix, above which CCT begins to shift downward. In addition, the MPCD becomes too high and the light becomes too green for the commercial applications of interest. In addition, the chemical activity of Tl may increase corrosivity, jeopardizing lifetime. Based on the above considerations, a range of from about 2 to about 3 mole percent of TlI is preferred. For CCTs above 5000K, however, the TlI level should be kept to about 1 mole percent or less.

### EXAMPLES

Arc tubes were formed according to the shape shown in the FIGURE. The shape has a form of a prolate spheroid with the short axis width W of about 18 mm and the long axis length L of about 26 mm. The wall thickness of the body is about 1 mm. End portions of the spheroid are integrally formed into a hollow axial extension, through which the tungsten discharge electrodes are inserted. Distance between the tungsten electrodes is 14 mm. A dose of Hg is added to the arc tube, as well as the salt mixture itself The arc tube was filled by Ar, with an addition of a small amount of Kr⁸⁵. The fill pressure was 75 Torr. Other inert gases like Xe, Ne, or a mix of those gases, can be used for the filling, as well. The discharge electrodes were sealed tightly in the extensions in the arc tube body.

The lamps were manufactured with a rated power of 315 W. Voltage of the lamps was about 100V, which was adjusted by the dose of Hg. The values of CCT, CRI, and MPCD are measured after the lamps had been operated vertically for 100 hours. Chemical fillings of the series of lamps, together with their parameters, are presented in Table 1:

| | | | | | | Lu- | | | |
|---|---|---|---|---|---|---|---|---|---|
| | | | | | | mi- | | | |
| | | | | | | nous | | | |
| Salt components, mol % | | | | | | effi- | | | |
| CsI | NaI | TlI | CeI₃ | CaI₂ | InI | cacy | CCT | CRI | MPCD |
| 4.35 | 0.00 | 2.27 | 4.34 | 87.17 | 1.87 | 107.7 | 4900 | 87 | 48 |
| 4.42 | 0.00 | 2.31 | 6.62 | 84.74 | 1.90 | 112.3 | 4900 | 86 | 56 |
| 4.37 | 2.52 | 2.28 | 6.54 | 82.40 | 1.88 | 114.1 | 4700 | 86 | 53 |
| 4.40 | 0.00 | 0.00 | 5.49 | 88.85 | 1.26 | 107.7 | 5000 | 89 | 22 |
| 4.41 | 0.00 | 1.15 | 5.50 | 87.68 | 1.26 | 110.7 | 5000 | 87 | 42 |
| 4.35 | 0.00 | 1.14 | 5.43 | 86.59 | 2.50 | 109.4 | 4800 | 89 | 46 |
| 4.35 | 0.00 | 0.00 | 5.42 | 87.74 | 2.49 | 106.0 | 4900 | 91 | 29 |

Table 1 shows that the measured lamps had luminous efficacies of from about 106 to 114 L/W, CCTs of 4700 to 5000K, CRIs of from 86 to 91, MPCDs of from 29 to 56.

The invention has necessarily been described in terms of a limited number of embodiments. From this description, other embodiments and variations of embodiments will become apparent to those skilled in the art, and are intended to be fully encompassed within the scope of the invention and the appended claims.

1. A ceramic gas discharge metal halide (CDM) lamp (23) comprising:
a ceramic discharge vessel (12) with a central portion (12a) enclosing a discharge space (20), and a pair of end portions (12b, 12c);
a pair of discharge electrodes (13, 14) extending through the respective end portions (12b, 12c) into the discharge space (14);
an outer glass envelope (10) surrounding the discharge vessel (12), and a base (25), the outer glass envelope (10) sealed to the base (25) to form a gas-tight enclosure for the discharge vessel (12);
characterized in that the discharge space (20) contains a fill comprised of an inert gas, mercury and a metal halide salt mixture, characterized in that the salt mixture comprises:
at least about 62 mole percent of calcium iodide (CaI₂);
up to about 8 mole percent of cerium iodide (CeI₃);
up to about 15 mole percent of cesium iodide (CsI); and
up to about 15 mole percent of one or more members selected from the group consisting of the halides of lithium (Li), sodium (Na), indium (In), manganese (Mn), lead (Pb), praseodymium (Pr), europium (Eu), gallium (Ga) and thallium (Tl), with the amount of the halides of sodium (Na) being less than about 5 mole percent, and the amount of the halides of thallium (Tl) being less than about 5 mole percent.

2. The ceramic gas discharge metal halide (CDM) lamp (23) of claim 1 in which calcium iodide (CaI₂) is present in the range of from about 62 to about 95 mole percent.

3. The ceramic gas discharge metal halide (CDM) lamp (23) of claim 1 in which cerium iodide (CeI₃) is present in the range of from about 2 to about 6 mole percent.

4. The ceramic gas discharge metal halide (CDM) lamp (23) of claim 1 in which cerium iodide (CsI) is present in the range of from about 3 to about 15 mole percent.

5. The ceramic gas discharge metal halide (CDM) lamp (23) of claim 1 in which thallium iodide (TlI) is present in the range of from about 2 to about 3 mole percent.

6. The ceramic gas discharge metal halide (CDM) lamp (23) of claim 1 in which thallium iodide (TlI) is present in the amount of up to about 1 mole percent.

7. The ceramic gas discharge metal halide (CDM) lamp (23) of claim 1 in which the shape of the central portion (12a) of the discharge vessel (12) is designed to accommodate high internal pressure and provide minimal thermal gradients.

8. The ceramic gas discharge metal halide (CDM) lamp (23) of claim 5 in which the shape of the central portion (12a) of the discharge vessel (12) is a prolate spheroid.
